(19) United States
(12) Patent Application Publication
(10) Pub. No.: US 2010/0045658 A1
(43) Pub. Date: Feb. 25, 2010

(54) PLASMA DISPLAY AND DRIVING METHOD THEREOF

(75) Inventor: Sung-Im Lee, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/544,879

(22) Filed: Aug. 20, 2009

(30) Foreign Application Priority Data
Aug. 21, 2008 (KR) 1020080082006

(51) Int. Cl. G06F 3/038; G09G 3/28

(52) U.S. Cl. 345/214; 345/60

(57) ABSTRACT

A plasma display and method of driving the display are disclosed. To form wall charges at each electrode such that the sustain discharge is generated, a positive voltage is applied to a plurality of sustain electrodes after a scan pulse is applied to the scan electrodes in an address period and before the first sustain pulse is applied to the plurality of scan electrodes in a sustain period.

### CROSS-REFERENCE TO RELATED APPLICATION

This application claims priority to and the benefit of Korean Patent Application No. 10-2008-0082006 filed in the Korean Intellectual Property Office on Aug. 21, 2008, the entire contents of which are incorporated herein by reference.

### BACKGROUND

1. Field

The field relates to a plasma display and a driving method thereof.

2. Description of the Related Technology

A plasma display is a display device using a plasma display panel for displaying characters or images by using plasma generated by a gas discharge.

The plasma display is driven with frames divided into a plurality of subfields each having a weight value, and displays a grayscale by a combination of weight values of the subfields in which a display operation is generated.

A discharge cell (hereinafter referred to as a “cell”) is initialized by a reset discharge during a reset period of each subfield. The reset period is either a main reset period or an auxiliary reset period. The reset discharge is generated in all the cells during the main reset period, and is only generated in the cells having undergone the sustain discharge in the previous subfield during the auxiliary reset period. During an address period of the subfields, a scan pulse is sequentially applied to a plurality of scan electrodes, and an address pulse is selectively applied to a plurality of address electrodes when the scan pulse is applied to each scan electrode, so that light emitting cells and non-light emitting cells are established. The address discharge occurs in a cell formed near by the scan electrode applied with the scan pulse and the address electrode applied with the address pulse.

The light emitting cell is sustain discharged during a sustain period of each subfield so that images are displayed.

However, since the scan pulse is sequentially applied to a plurality of scan electrodes, wall charges of the light emitting cell applied with the scan pulse may be erased if the scan pulse is late. As a result, the address discharge may not appropriately occur. Particularly, in the auxiliary reset period, only the light emitting cells having undergone the sustain discharge in the previous subfield are initialized, and it is difficult to compensate the wall charges erased at the non-light emitting cells.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a method of driving a plasma display including a plurality of first electrodes and a plurality of second electrodes extending in one direction, and a plurality of third electrodes crossing the first electrodes and the second electrodes, each frame being divided into a plurality of subfields. The method includes gradually decreasing a voltage at the plurality of first electrodes from a first voltage to a second voltage during a reset period of at least one subfield, sequentially applying a third voltage to each of the plurality of first electrodes during a portion of an address period of the at least one subfield and applying a fourth voltage that is higher than the third voltage to the first electrodes to which the third voltage is not being applied, applying a plurality of first sustain pulses having a first high level voltage and a first low level voltage to the plurality of first electrodes during a sustain period of the at least one subfield, applying a plurality of second sustain pulses having a second high level voltage and a second low level voltage to the plurality of second electrodes in a phase opposite to the plurality of first sustain pulses during the sustain period of the at least one subfield, and applying a positive voltage to the plurality of second electrodes after the third voltage is applied to the first electrodes and before the first sustain pulses are applied to the plurality of first electrodes.

Another aspect is a plasma display including a plurality of first and second electrodes extending in one direction, a plurality of third electrodes crossing the plurality of first and second electrodes, a controller configured to divide a frame into a plurality of subfields, and a driver. The driver is configured to gradually decrease a voltage at the plurality of first electrodes from a first voltage to a second voltage during a reset period of at least one subfield, sequentially apply a third voltage to each of the plurality of first electrodes during a portion of an address period of the at least one subfield and to apply a fourth voltage that is higher than the third voltage to the first electrodes to which the third voltage is not being applied, apply a plurality of sustain pulses to the plurality of first and second electrodes during a sustain period of the at least one subfield, and apply a positive voltage to the plurality of second electrodes after the third voltage is applied to the first electrodes and before the first sustain pulse is applied to the plurality of first electrodes.

Another aspect is a method of driving a plasma display including a plurality of first electrodes and a plurality of second electrodes extending in one direction, and a plurality of third electrodes crossing the first electrodes and the second electrodes, each frame being divided into a plurality of subfields. The method includes sequentially applying a third voltage to each of the plurality of first electrodes during a portion of an address period of the at least one subfield and applying a fourth voltage that is higher than the third voltage to the first electrodes to which the third voltage is not being applied, applying a first voltage to the second electrodes during the address period, applying a plurality of sustain pulses to the plurality of first and second electrodes during a sustain period of the at least one subfield, and applying a second voltage to the plurality of second electrodes after the third voltage is applied to the first electrodes and before the first sustain pulses are applied to the plurality of first electrodes, where the second voltage is different from the first voltage.

### BRIEF DESCRIPTION OF THE DRAWINGS

FIG. 1 is a drawing showing a plasma display according to an exemplary embodiment.

FIG. 2 is a drawing showing an arrangement of the subfields and a reset waveform applied to each subfield.

FIG. 3 is a drawing showing a driving waveform of the plasma display device according to an exemplary embodiment.

FIG. 4 is a drawing showing a relation between a voltage applied to the Y electrode in a falling period of a reset period and wall charges.

FIG. 5 to FIG. 7 are drawings showing driving waveforms of the plasma display device according to additional exemplary embodiments.

### DETAILED DESCRIPTION OF CERTAIN INVENTIVE EMBODIMENTS

One exemplary embodiment includes a method of driving a plasma display including a plurality of first electrodes and a plurality of second electrodes extending in one direction, and a plurality of third electrodes crossing the first electrodes and the second electrodes. The method includes dividing a frame into a plurality of subfields. According to the method, a voltage at the plurality of first electrodes is gradually decreased from a first voltage to a second voltage during a reset period of at least one subfield among the plurality of subfields, a third voltage is sequentially applied to the plurality of first electrodes during an address period of the at least one subfield, a fourth voltage that is higher than the third voltage is applied to the first electrode to which the third voltage is not applied among the plurality of first electrodes during the address period of the at least one subfield, a plurality of first sustain pulses having a first high level voltage and a first low level voltage are applied to the plurality of first electrodes during a sustain period of the at least one subfield, a plurality of second sustain pulses having a second high level voltage and a second low level voltage are applied to the plurality of second electrodes in a phase opposite to the plurality of first sustain pulses during the sustain period of the at least one subfield, and a positive voltage is applied to the plurality of second electrodes during a first period among a period from after the third voltage is applied to a last first electrode to before the first sustain pulses is applied to the plurality of first electrodes.

Another exemplary embodiment includes a plasma display including a plurality of first and second electrodes, a plurality of third electrodes, a controller, and a driver. The plurality of first and second electrodes extend in one direction, and the plurality of third electrodes cross the plurality of first and second electrodes. The controller divides a frame into a plurality of subfields, and the driver gradually decreases a voltage at the plurality of first electrodes from a first voltage to a second voltage during a reset period of at least one subfield among the plurality of subfields. The controller sequentially applies a third voltage to the plurality of first electrodes and applies a fourth voltage that is higher than the third voltage to the first electrode to which the third voltage is not applied among the plurality of first electrodes during an address period of the at least one subfield. The controller also alternately applies a plurality of sustain pulses to the plurality of first and second electrodes during a sustain period of the at least one subfield. The driver applies a positive voltage to the plurality of second electrodes during at least one period after the third voltage is applied to a last first electrode and before the first sustain pulse is applied to the plurality of first electrodes.

According to some exemplary embodiments, erased wall charges of the non-light emitting cells can be compensated without applying a rising waveform for forming the wall charges in the auxiliary reset period.

In the following detailed description, only certain exemplary embodiments have been shown and described, simply by way of illustration. As those skilled in the art would realize, the described embodiments may be modified in various different ways. Accordingly, the drawings and description are to be regarded as illustrative in nature. Like reference numerals generally designate like elements throughout the specification.

Wall charges indicate charges formed on a wall of discharge cells neighboring each electrode and accumulated to electrodes. Although the wall charges do not actually touch the electrodes, it will be described that the wall charges are “generated,” “formed,” or “accumulated” thereon. Also, a wall voltage represents a potential difference formed on the wall of the discharge cells by the wall charges. A weak discharge is a discharge that is weaker than a sustain discharge in a sustain period and an address discharge in an address period.

Plasma displays and driving methods thereof according to exemplary embodiments will now be described.

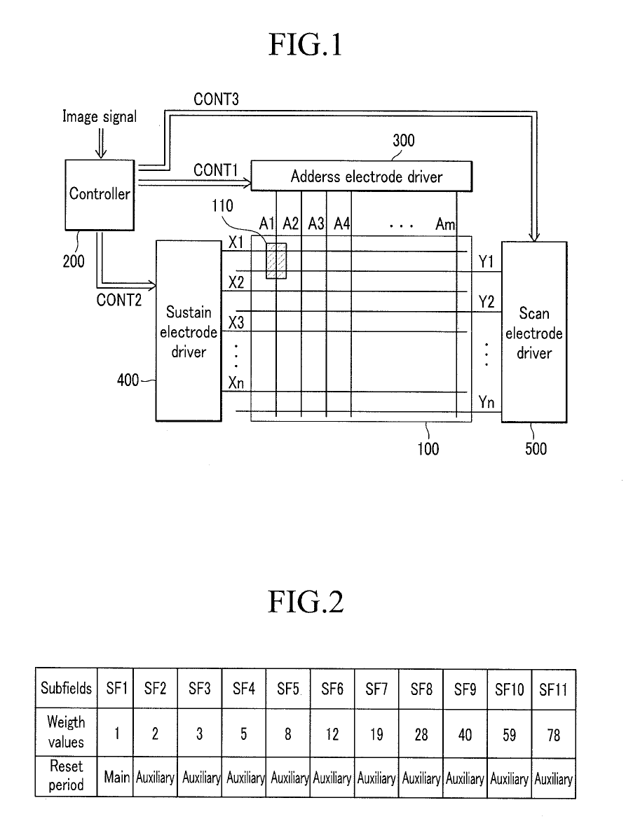

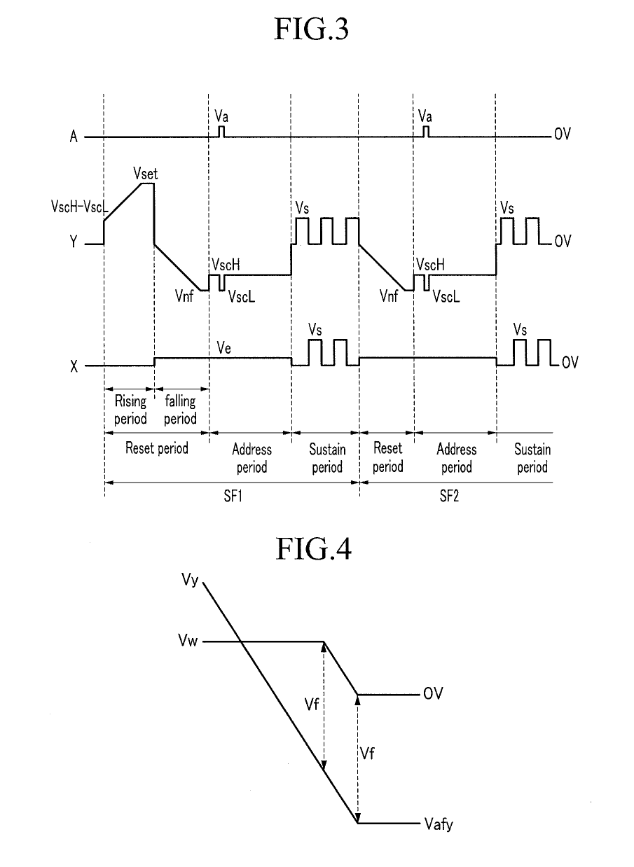

FIG. 1 is a drawing showing a plasma display according to an exemplary embodiment, and FIG. 2 is a drawing showing an arrangement of the subfields and a reset waveform applied to each subfield.

As shown in FIG. 1, the plasma display according to an exemplary embodiment includes a plasma display panel 100, a controller 200, an address electrode driver 300, a sustain electrode driver 400, and a scan electrode driver 500.

The plasma display panel 100 includes a plurality of address electrodes A1-Am (referred to as “A” electrodes hereinafter) extending in a column direction, and a plurality of sustain electrodes X1-Xn (referred to as “X” electrodes hereinafter) and a plurality of scan electrodes Y1-Yn (referred to as “Y” electrodes hereinafter) extending in a row direction, in pairs. In general, the X electrodes X1-Xn are formed to correspond to the respective Y electrodes Y1-Yn, and the X electrodes X1-Xn and the Y electrodes Y1-Yn perform a display operation during a sustain period in order to display an image. The Y electrodes Y1-Yn and the X electrodes X1-Xn are disposed to cross the A electrodes A1-Am. A discharge space at each crossing area of the A electrodes A1-Am and the X and Y electrodes X1-Xn and Y1-Yn forms a discharge cell 110. The structure of the PDP 100 shows one example, and a panel with a different structure to which driving waveforms described herein can be applied can also be used.

The controller 200 receives an image signal and generates an A electrode driving control signal CONT1, an X electrode driving control signal CONT2, and a Y electrode driving control signal CONT3 and outputs the A electrode driving control signal CONT1, the X electrode driving control signal CONT2, and the Y electrode driving control signal CONT3 to the address, sustain, and scan electrode drivers 300, 400, and 500, respectively.

As shown in FIG. 2, the controller 200 drives a frame by dividing it into a plurality of subfields each having a weight value. For example, one frame can include 11 subfields SF1-SF11 respectively having weight values 1, 2, 3, 5, 8, 12, 19, 28, 40, 59, and 78, and grayscales may be displayed from the grayscale 0 to the grayscale 255 by summing the respective weights, as shown in FIG. 2. Each subfield SF1-SF11 includes a reset period, an address period, and a sustain period. The reset period of one subfield among a plurality of subfields SF1-SF11 may be formed of a main reset period, and the reset period of the other subfields may be formed of auxiliary reset periods. FIG. 2 shows the reset period of the subfield SF1 as a main reset period, and the reset periods of the subfields SF2-SF11 as auxiliary reset periods.

The address electrode driver 300 receives the A electrode driving control signal CONT1 from the controller 200 and applies a driving voltage to the A electrodes A1-Am.

The sustain electrode driver 400 receives the X electrode driving control signal CONT2 from the controller 200 and applies a driving voltage to the X electrodes X1-Xn.

The scan electrode driver 500 receives the Y electrode driving control signal CONT3 from the controller 200 and applies a driving voltage to the Y electrodes Y1-Yn.

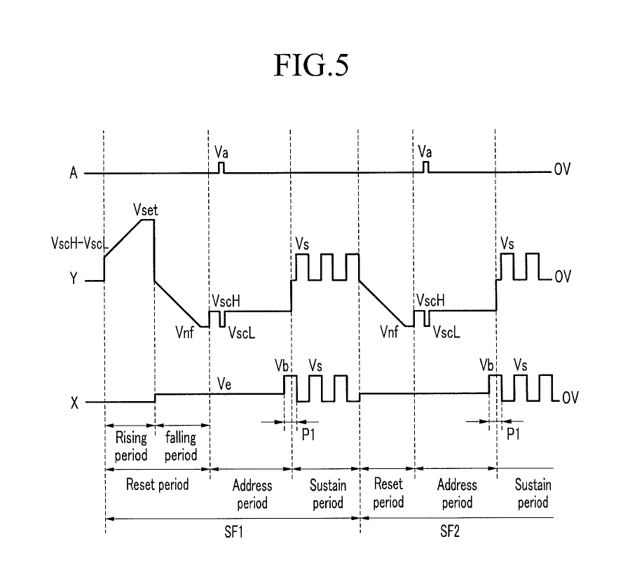

FIG. 3 is a drawing showing a driving waveform of the plasma display device according to an exemplary embodiment. FIG. 3 shows two subfields SF1 and SF2 among the plurality of subfields of one frame. In FIG. 3, the driving waveforms will be described with a cell formed with an A electrode, an X electrode, and a Y electrode.

As shown in FIG. 3, during a rising period of the reset period, the address electrode driver 300 and the sustain electrode driver 400 bias the A and X electrodes to a reference voltage (0V in FIG. 3), respectively, and the scan electrode driver 500 gradually increases the voltage at the Y electrodes from a voltage (VscH−VscL) to a voltage Vset.

In FIG. 3, the voltage at the Y electrode is shown to increase in a ramp pattern. Then, while the voltage at the Y electrode is increasing, a weak discharge occurs between the Y and X electrodes and between Y and A electrodes, forming negative (−) wall charges in the Y electrodes and positive (+) wall charges in the X and A electrodes. The Vset voltage may be set to be larger than a discharge firing voltage between the X electrode and the Y electrode in order to generate discharge at all cells.

Subsequently, in a falling period of the reset period, the sustain electrode driver 400 biases the X electrode with a voltage Ve, and the scan electrode driver 500 gradually decreases the voltage at the Y electrode from the voltage 0V to a voltage Vnf. In FIG. 3, the voltage at the Y electrodes is shown to decrease in the ramp pattern. Then, while the voltage at the Y electrodes is decreasing, a weak discharge occurs between the Y and X electrodes and between the Y and A electrodes, erasing the negative (−) wall charges formed in the Y electrodes and the positive (+) wall charges formed in the X and A electrodes.

In general, the voltage Ve and the voltage Vnf may be set so that the wall voltage between the Y electrode and the X electrode is near 0V in order to prevent a misfiring discharge in non-light emitting cells.

Further, since the reference voltage is applied to the A electrode, the wall voltage is determined by the level of the voltage Vnf. The voltage Vnf corresponds to a voltage that is less than a voltage −Vfay, where Vfay is a discharge firing voltage between the A electrode and the Y electrode.

Discharge characteristics when applying a ramp voltage falling to the voltage −Vfay will now be described.

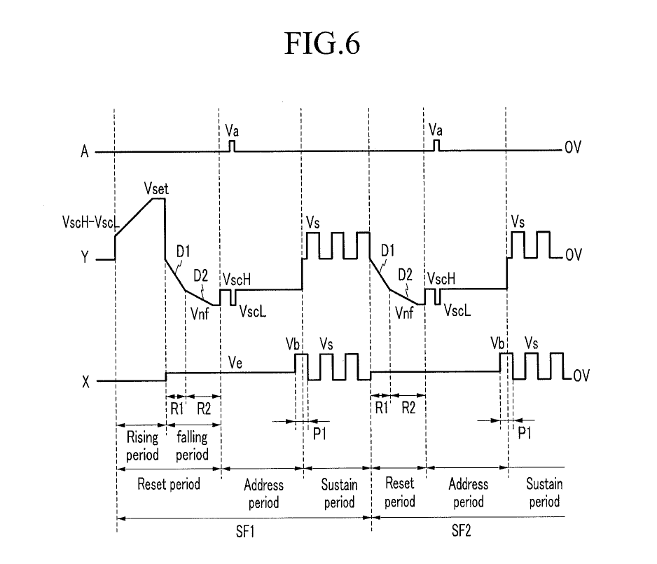

FIG. 4 is a drawing showing a relation between a voltage applied to the Y electrode in a falling period of a reset period and wall charges. Descriptions will be focused on the Y electrode and the A electrode in FIG. 4, and it is noted that the negative (−) wall charges and the positive (+) wall charges are respectively accumulated to the Y electrode and the A electrode, and therefore a predetermined amount of wall voltage Vw is formed before the falling period of the reset period.

As shown in FIG. 4, in the falling period of the reset period, a discharge is generated when a difference between the wall voltage Vw and a voltage Vy applied to the Y electrode is greater than the discharge firing voltage Vfay while the voltage Vy applied to the Y electrode is gradually decreased. When the discharge is generated, the wall voltage Vw in the cell is decreased corresponding to the voltage Vy applied to the Y electrode. The difference between the wall voltage Vw and a voltage Vy applied to the Y electrode is maintained at the discharge firing voltage Vfay. Thus, as shown in FIG. 4, the wall voltage Vw between the A electrode and the Y electrode in the cell becomes 0V when the voltage Vy applied to the Y electrode is decreased to the voltage −Vfay.

The difference between the voltage 0V applied to the A electrode and the voltage Vnf applied to the Y electrode is a voltage Vay reset, and is equal to the absolute value of the voltage Vnf. The voltage Vnf may satisfied Equation 1. That is, the absolute value of the voltage Vnf may be greater than the discharge firing voltage Vfay.

Vay_reset=|Vnf|≧Vfay Eq. 1

In this case, the negative (−) wall voltage may be formed in the cell when the absolute value of the voltage Vnf is greater than the discharge firing voltage Vfay. Further, when a deviation exists in the discharge firing voltage Vfay of the plurality of cells, the absolute value of the voltage Vnf may be greater than a maximum discharge firing voltage among the discharge firing voltage Vfay of the plurality of cells. Then, the negative (−) wall voltage is formed in the cell having a discharge firing voltage Vfay that is less than the maximum discharge firing voltage. That is, the negative (−) wall charges may be formed at the A electrode and the positive (+) wall charges may be formed at the Y electrode. At this time, the formed wall voltage may eliminate disparity between the cells in the address period.

In the address period, in order to select a light emitting cell and a non-light emitting cell, the sustain electrode driver 400 maintains the voltage at the X electrode at the voltage Ve, and the scan electrode driver 500 and the address electrode driver 300 apply a scan pulse having a voltage VscL and an address pulse having a voltage Va to the Y electrode and the A electrode, respectively. Then, an address discharges occur in cells formed by the Y electrode applied the voltage VscL and the A electrodes applied with the voltage Va. As a result, positive (+) wall charges are formed at the Y electrode and negative (−) wall charges are formed at the A and X electrodes.

Further, the scan electrode driver 500 applies a voltage VscH that is higher than the voltage VscL to the Y electrode to which the voltage VscL is not applied, and the address electrode driver 300 applies the reference voltage to the A electrode to which the voltage Va is not applied.

During the address period, the scan electrode driver 500 and the address electrode driver 300 apply scan pulses to the Y electrode (Y1 in FIG. 1) of a first row, and at the same time apply address pulses to the A electrodes positioned at light emitting cells in the first row. Then, address discharges occur between the Y electrodes (Y1 in FIG. 1) of the first row and the A electrodes to which the address pulses have been applied, forming positive (+) wall charges in the Y electrode (Y1 in FIG. 1) and negative (−) wall charges in the A and X electrodes. Subsequently, while the scan electrode driver 500 applies scan pulses to the Y electrode (Y2 in FIG. 1) of a second row, the address electrode driver 300 applies address pulses to the A electrodes positioned at light emitting cells of the second row. Then, address discharges occur at cells formed by the A electrodes to which the address pulses have been applied and the Y electrode (Y2 in FIG. 1) of the second row, forming wall charges in the cells. Likewise, while the scan electrode driver 500 sequentially applies scan pulses to the Y electrodes of the remaining rows, the address electrode driver 300 applies address pulses to the A electrodes positioned at light emitting cells to form wall charges.

Next, in the sustain period, the scan electrode driver 500 applies the sustain pulse alternately having a high level voltage (Vs in FIG. 3) and a low level voltage (0V in FIG. 3) to the Y electrodes a number of times corresponding to a weight value of the subfield. In addition, the sustain electrode driver 400 applies a sustain pulse to the X electrodes in a phase opposite to that of the sustain pulse applied to the Y electrodes. That is, 0V are applied to the X electrode when a voltage Vs is applied to the Y electrode, and the voltage Vs is applied to the X electrode when 0V are applied to the Y electrode.

In this case, the voltage difference between the Y electrode and the X electrode alternately has a voltage Vs and a voltage −Vs. Accordingly, the sustain discharge repeatedly occurs at light emitting cells a number of times corresponding to the weight of the subfield.

In the auxiliary reset period of the subfield SF2, the sustain electrode driver 500 and the address electrode driver 300 apply the voltage Ve and the reference voltage to the X electrode and the A electrode, and the scan electrode driver 500 gradually decreases the voltage at the Y electrodes from the voltage 0V to the voltage Vnf. Then, while the voltage at the Y electrodes is decreasing, a weak discharge is generated between the Y and X electrodes of the light emitting cell and between the Y and A electrodes of the light emitting cell. Thus, the negative (−) wall charges formed in the Y electrodes are erased, and the positive (+) wall charges formed in the X and A electrodes are erased.

Further, since the voltage Vnf is set as the voltage that is less than the voltage −Vfay, while the voltage at the Y electrodes is decreasing to the voltage Vnf, a weak discharge is generated between the Y and X electrodes of the non-light emitting cell and between the Y and A electrodes of the non-light emitting cell to be less than the weak discharge of the light emitting cells. As a result, the negative (−) wall charges formed in the Y electrodes are erased, and positive (+) wall charges are formed at the Y electrode of the non-light emitting cell and negative (−) wall charges are formed at the X and A electrodes of the non-light emitting cell.

That is, when the voltage Vnf is less than the voltage −Vfay, although positive (+) wall charges formed at the Y electrode and negative (−) wall charges formed at the Y electrode in the non-light emitting cells are erased in the subfield SF1, wall charges erased in the non-light emitting cell may be compensated using only a waveform gradually decreasing the voltage at the Y electrode to the voltage Vnf in the auxiliary reset period of the subfield SF2. Therefore, an operation for gradually increasing the voltage at the Y electrode does not have to be performed in order to compensate the wall charges of the non-light emitting cell in the auxiliary reset period of the subfield SF2.

In addition, when the voltage Vnf voltage is equal to the voltage −Vfay, the wall voltage between the A electrode and Y electrode becomes 0V when the main reset period is finished, and there is no wall charge. Thus, when the voltage Vnf voltage is equal to the voltage −Vfay, the special operation for compensating the wall charges of the non-light emitting cell does not have to be performed.

In the subfield SF2, the light emitting cell and the non-light emitting cell are selected by the address discharge in the address period, and the sustain discharge operation is performed for the light emitting cell in the sustain period.

Next, a relationship between the voltage Vs and the discharge firing voltage Vfxy between the X electrode and the Y electrode, and the discharge firing voltage Vfay between the A electrode and the Y electrode will be described.

A discharge of the plasma display panel is determined by the quantity of secondary electrons discharged when positive ions collide with a negative electrode. The discharge firing voltage when the electrode covered with a material having a high secondary emission coefficient functions as the negative electrode is less than the discharge firing voltage when the electrode covered with a material having a low secondary emission coefficient functions as the negative electrode. In a three electrode plasma display panel, the address electrode formed on a rear substrate is covered with a phosphor for color representation, and the scan electrode and the sustain electrode formed on a front substrate are covered with a dialectic layer formed of MgO for a sustain-discharge. The secondary emission coefficient of the dialectic layer formed of MgO is high, and the secondary emission coefficient of the phosphor layer is low. The scan electrode and the sustain electrode are symmetrically formed. However, the address electrode and the scan electrode are asymmetrically formed, and therefore the discharge firing voltage between the address electrode and the scan electrode varies according to whether the address electrode functions as a positive electrode or a negative electrode.

That is, a discharge firing voltage Vfay when the address electrode covered with the phosphors functions as the positive electrode and the scan electrode covered with the dialectic layer functions as the negative electrode is less than a discharge firing voltage Vfya when the address electrode functions as the negative electrode and the scan electrode functions as the positive electrode. A relation of Equation 2 is satisfied between the discharge firing voltage Vfay when the address electrode is the positive electrode, the discharge firing voltage Vfya when the address electrode is the negative electrode, and the discharge firing voltage Vfxy. The relation may be varied according to the discharge cell state.

Vfay+Vfya=2Vfxy Eq. 2

The scan electrode functions as the negative electrode in the reset period and the address period, and therefore the discharge firing voltage Vfay between the address electrode and the scan electrode satisfies Equation 3 derived from Equation 2. The sustain-discharge is not generated in the discharge cell that is not addressed in the address period, and therefore the voltage Vs is less than the discharge firing voltage Vfxy between the scan electrode and the sustain electrode as shown in Equation 4.

Vfay<Vfxy Eq. 3

Vs<Vfxy Eq. 4

The wall voltage between the address electrode and the scan electrode is established to be near 0V in the reset period of some embodiments. Therefore, in a discharge cell that is not addressed in the address period, discharges are not sequentially generated between the scan electrode and the address electrode, or between the sustain electrode and the address electrode. That is, a sequence discharge is generated when the voltage Vs is applied to the scan electrode, a discharge is generated between the scan electrode and the address electrode, and another discharge is generated between the sustain electrode and the address electrode when positive wall charges are formed in the address electrode by the discharge (between the scan electrode and the address electrode) and the voltage Vs is applied to the sustain electrode. The sustain electrode and the scan electrode are symmetrical electrodes, and therefore a discharge firing voltage Vfax between the address electrode and the sustain electrode corresponds to the voltage Vfay, and a wall voltage formed in the sustain electrode and the address electrode when the positive wall charges are accumulated by the discharge between the scan electrode and the address electrode is not greater than the discharge firing voltage Vfay. Accordingly, the discharge firing voltage Vfay is greater than a voltage Vs/2 in order to not generate the discharge when the voltage Vs is applied to the sustain electrode after the positive wall charges are formed in the sustain electrode by the discharge between the scan electrode and the address electrode, which is shown in Equation 5.

Vs−Vfay<Vfay

Vfay>Vs/2 Eq. 5

In Equation 3 to Equation 5, the discharge firing voltage Vfay is set to be greater than the voltage Vs/2, and is determined to be around the voltage Vs because the discharge firing voltage Vfay and the voltage Vs are less than the discharge firing voltage Vfxy. That is, Equation 6 is satisfied.

Vfay≈Vs Eq. 6

The voltage applied to the A electrode in the reset period is 0V. However, since the wall voltage between the A electrode and the Y electrode is determined by the difference between the voltage applied to the A electrode and the voltage applied to the Y electrode, the voltage applied to the A electrode and the voltage applied to the Y electrode may be different from that shown in FIG. 3.

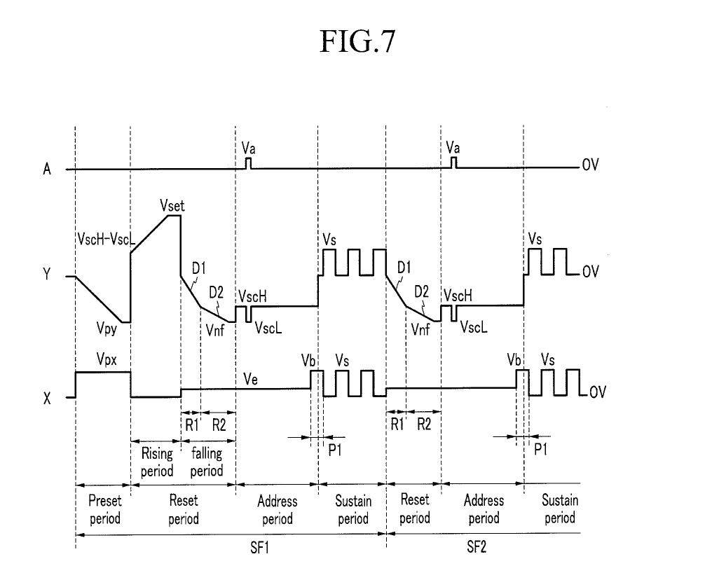

FIG. 5 is drawing showing a driving waveform of the plasma display device according to another embodiment.

As shown in FIG. 5, in the address period of each subfield SF1 and SF2, during a period P1 from after the scan pulse is applied to the last Y electrode to before a first sustain pulse is applied to the Y electrode, the sustain electrode driver 400 applies a positive voltage Vb to the X electrode. At this time, the positive voltage Vb has a magnitude that can form wall charges at each electrode such that the sustain discharge is generated. Further, when the voltage Vs is used as the positive voltage Vb, an additional power source is not required.

As described above with regard to the embodiment of FIG. 3, when the absolute value of the voltage Vnf is greater than the maximum discharge firing voltage, because a large quantity of wall charges are formed at the Y electrode by the address discharge, the probability that a self-erase discharge occurs when the voltage at the Y electrode is charged from the voltage VscH to the voltage 0V increases. Accordingly, the positive (+) wall charges formed at the Y electrode may be erased, and the sustain discharge may not be appropriately generated when the first sustain pulse is applied to the Y electrode in the sustain period. However, in the embodiment of FIG. 5, during the period P1, when the positive voltage Vb is applied to the X electrode, although the positive (+) wall charges formed at the Y electrode are erased by the self-erase discharge, because sufficient negative (−) wall charges are formed at the X electrode, the sustain discharge is appropriately generated.

FIG. 6 and FIG. 7 are drawings showing driving waveforms of the plasma display device according to other exemplary embodiments.

As shown in FIG. 6, the scan electrode driver 500 may gradually decrease the voltage at the Y electrode to the voltage Vnf with at least two slopes. That is, the scan electrode driver 500 decreases the voltage at the Y electrode with a steep slope D1 during a period R1 in which a weak discharge between the Y electrode and the X electrode, and the Y electrode and the A electrode does not occur, and decreases the voltage at the Y electrode with a gentle slope D2 during the other period R2. In this way, the duration of reset period may be reduced.

Further, as shown in FIG. 7, a preset period may be included before the rising period of the main reset period. In the preset period, the sustain electrode driver 400 applies a voltage Vpx to the X electrode and the scan electrode driver 500 gradually decreases the voltage at the Y electrode from the reference voltage to a voltage Vpy. Further, the address electrode driver 300 applies the reference voltage to the A electrode. Accordingly, in the preset period, a difference between a voltage at the X electrode and a voltage at the Y electrode may be set to be satisfy Equation 7.

|Ve−Vnf|<|Vpx−Vpy| Eq. 7

As a result, because the voltage Ve and the voltage Vnf may be set so that the wall voltage between the Y electrode and the X electrode is near 0V, when the absolute value of a voltage (Vpx−Vpy) is greater than the absolute value of a voltage (Ve−Vnf), positive (+) wall charges and negative (−) wall charges may be properly formed at the Y electrode and the X electrode of all the cells, respectively.

In addition, in the preset period, since the reference voltage is applied to the A electrode, the difference between the A electrode and the Y electrode is less than the discharge firing voltage Vfay. Thus, the discharge between the A electrode and Y electrode is not generated. That is, since a voltage difference between the Y electrode and the A electrode when the reset period is finished is less than a voltage difference between the Y electrode and the A electrode when the preset period is finished, the discharge between the A electrode and Y electrode is not generated.

In this way, because sufficient wall charges may be formed at the Y electrodes during the preset period, the voltage Vset may be set to be a voltage Vset′ which is less than the voltage Vset. At this time, in order to reduce the number of power sources, the voltage Vpy may be set to be equal to the voltage Vnf. When the voltage Vpy is set to be equal to the voltage Vnf, the voltage Vpx may be set to be higher than the voltage Ve according to the Equation 7. In contrast, the voltage Vpx may set to be equal to the voltage Ve. When the voltage Vpx is set to be equal to the voltage Ve, the voltage Vpy may be set to be lower than the voltage Vnf according to the Equation 7.

While this invention has been described in connection with what is presently considered to be practical exemplary embodiments, it is to be understood that the invention is not limited to the disclosed embodiments, but, on the contrary, is intended to cover various modifications and equivalent arrangements.

What is claimed is:

1. A method of driving a plasma display including a plurality of first electrodes and a plurality of second electrodes extending in one direction, and a plurality of third electrodes crossing the first electrodes and the second electrodes, each frame being divided into a plurality of subfields, the method comprising:
gradually decreasing a voltage at the plurality of first electrodes from a first voltage to a second voltage during a reset period of at least one subfield;
sequentially applying a third voltage to each of the plurality of first electrodes during a portion of an address period of the at least one subfield and applying a fourth voltage that is higher than the third voltage to the first electrodes to which the third voltage is not being applied;
applying a plurality of first sustain pulses having a first high level voltage and a first low level voltage to the plurality of first electrodes during a sustain period of the at least one subfield;
applying a plurality of second sustain pulses having a second high level voltage and a second low level voltage to the plurality of second electrodes in a phase opposite to the plurality of first sustain pulses during the sustain period of the at least one subfield; and
applying a positive voltage to the plurality of second electrodes after the third voltage is applied to the first electrodes and before the first sustain pulses are applied to the plurality of first electrodes.

2. The method of claim 1, further comprising:
applying a fifth voltage to the plurality of third electrodes while the second voltage is applied to the plurality of first electrodes in the reset period,
wherein the third voltage minus the fifth voltage is less than half of the second low level voltage minus the first high level voltage.

3. The method of claim 2, wherein the third voltage minus the fifth voltage is less than the second low level voltage minus the first high level voltage.

4. The method of claim 2, wherein the third voltage minus the fifth voltage is less than a discharge firing voltage between the plurality of third electrodes and the plurality of first electrodes.

5. The method of claim 1, wherein the positive voltage is equal to the second high level voltage.

6. The method of claim 5, further comprising:
gradually increasing the voltage at the plurality of first electrodes from a seventh voltage to an eighth voltage during the reset period of the at least one subfield.

7. The method of claim 6, further comprising:
applying a ninth voltage to the plurality of second electrodes while the second voltage is applied to the plurality of first electrodes in the reset period of the at least one subfield; and
gradually decreasing the voltage at the plurality of first electrodes from an eleventh voltage to a twelfth voltage while a tenth voltage is applied to the plurality of second electrodes during a second period before the reset period,
wherein the ninth voltage minus the second voltage is less than the tenth voltage minus the twelfth voltage.

8. The method of claim 5, wherein:
gradually decreasing to the second voltage comprises
gradually decreasing the voltage at the plurality of first electrodes from the first voltage to a seventh voltage that is higher than the second voltage with a first slope; and
gradually decreasing the voltage at the plurality of first electrodes from the seventh voltage to the second voltage with a second slope that is lower magnitude than the first slope.

9. A plasma display comprising:
a plurality of first and second electrodes extending in one direction;
a plurality of third electrodes crossing the plurality of first and second electrodes;
a controller configured to divide a frame into a plurality of subfields; and
a driver configured to:
gradually decrease a voltage at the plurality of first electrodes from a first voltage to a second voltage during a reset period of at least one subfield;
sequentially apply a third voltage to each of the plurality of first electrodes during a portion of an address period of the at least one subfield and to apply a fourth voltage that is higher than the third voltage to the first electrodes to which the third voltage is not being applied;
apply a plurality of sustain pulses to the plurality of first and second electrodes during a sustain period of the at least one subfield; and
apply a positive voltage to the plurality of second electrodes after the third voltage is applied to the first electrodes and before the first sustain pulse is applied to the plurality of first electrodes.

10. The plasma display of claim 9, wherein after the third voltage is applied to the first electrodes and before the first sustain pulse is applied to the plurality of first electrodes, the voltage at the plurality of first electrodes is changed from the fourth voltage to the low level voltage, and the fourth voltage is lower than the low level voltage.

11. The plasma display of claim 9, wherein the driver is further configured to apply a fifth voltage to the plurality of third electrodes while the second voltage is applied to the plurality of first electrodes in the reset period, and wherein the third voltage minus the fifth voltage is less than half of the low level voltage minus the high level voltage.

12. The plasma display of claim 11, wherein the third voltage minus the fifth voltage is less than the second low level voltage minus the first high level voltage.

13. The plasma display of claim 11, wherein the third voltage minus the fifth voltage is less than a discharge firing voltage between the plurality of third electrodes and the plurality of first electrodes.

14. The plasma display of claim 10, wherein the positive voltage is equal to the high level voltage.

15. A method of driving a plasma display including a plurality of first electrodes and a plurality of second electrodes extending in one direction, and a plurality of third electrodes crossing the first electrodes and the second electrodes, each frame being divided into a plurality of subfields, the method comprising:
sequentially applying a third voltage to each of the plurality of first electrodes during a portion of an address period of the at least one subfield and applying a fourth voltage that is higher than the third voltage to the first electrodes to which the third voltage is not being applied;
applying a first voltage to the second electrodes during the address period;
applying a plurality of sustain pulses to the plurality of first and second electrodes during a sustain period of the at least one subfield; and
applying a second voltage to the plurality of second electrodes after the third voltage is applied to the first electrodes and before the first sustain pulses are applied to the plurality of first electrodes, wherein the second voltage is different from the first voltage.

16. The method of claim 15, wherein the second voltage is greater than the first voltage.

17. The method of claim 15, wherein the sustain pulses comprise a high voltage and a low voltage, and wherein the first voltage is greater than the low voltage.

18. The method of claim 15, wherein the sustain pulses comprise a high voltage and a low voltage, and the second voltage is substantially equal to the high voltage.

19. The method of claim 15, wherein the sustain pulses comprise a high voltage and a low voltage, and the method further comprises applying the low voltage to the first electrodes after the third voltage is applied to the first electrodes and before the first sustain pulses are applied to the plurality of first electrodes.

20. The method of claim 19, wherein the low voltage is substantially equal to a ground voltage.
